(19) United States
(12) Patent Application Publication
(10) Pub. No.: US 2004/0262434 A1
(43) Pub. Date: Dec. 30, 2004

(54) Triversing, angle adjusted surface cleaning sprayer

(76) Inventor: Lynn A. Buckner, Chickamauga, GA (US)

Correspondence Address: LYNN A. BUCKNER, P.O. Box 609, Chickamauga, GA, 30707, US

(21) Appl. No.: 10/609,201

(22) Filed: Jun. 27, 2003

(51) Int. Cl. B08B 3/00

(52) U.S. Cl. 239/754; 239/722; 239/173; 239/176; 134/123; 15/300.1; 15/302

(57) ABSTRACT

A surface cleaning or surface conditioning pressure sprayer which has one or more liquid sprayers with a source of pressurized liquid. The sprayer is mounted on one or more liquid spray headers. The header is moved in a traversing motion by a connecting arm attached to a rotary cam. An angle adjustment device moves the header on a pivot in order to accomplish the most effective angle of attack for cleaning between the surface to be cleaned or conditioned and the pressurized liquid spray. The above described device may be mounted on a support having a mobility means, a housing to contain and manage liquid and air flow. Airflow, air velocity, air temperature, air dryness and air impingement may be adjusted to improve cleaning and drying of the surface to be cleaned.

### BACKGROUND OF THE INVENTION

State of the art high pressure surface spray nozzle cleaners are hand held or fixed position or rotary sprayers.

### BRIEF SUMMARY OF THE INVENTION

It is an objective of this invention to provide a liquid sprayer device which is automated to move the sprayed liquid, as it impinges the surface to be sprayed, in other than a circular pattern.

It is yet another objective of the invention to set the angle of attack, between the liquid spray & the surface to be sprayed, at an angle best suited to clean, remove or demolition the sprayed surface.

It is yet another objective of the invention to provide a device to adjust the angle of attack between the liquid & the surface to be spray.

It is yet another objective of the invention to provide a device to mobilize the sprayer unit.

It is yet another objective of the invention to provide a housing device in proximity to the sprayer unit to contain & direct the flow of air around the sprayer unit.

It is yet another objective of the invention to provide a device to move a plurality of liquid sprayers which have been adjusted to the optimum angle of attack, back & forth or traversing or reciprocating parallel to the surface to be sprayed.

### BRIEF DESCRIPTION OF THE DRAWINGS

FIG. 1 is a top view of a spray header 2 with multiple liquid sprayer heads 1 and a rotating cam 3 which rotates in order to power the liquid spray header 2 in a traversing motion 4. The connecting rod 15 transfers the motion from the rotating cam 3 to the liquid spray header 2.

FIG. 2 is a side view of FIG. 1 with the addition of a support device 8 to mount the liquid spray header 2 to, and a liquid spray header angle adjustment device 7 to alter the angle of attack between the surface to be sprayed 5 and the liquid sprayer 1. The liquid spray header 2 rotates on a pivot 6.

FIG. 3 is a side view of FIG. 2 with the addition of a mobility device 14 which may be moved by hand or mechanically powered or robotically manipulated.

FIG. 4 is a top view similar to FIG. 1 with the addition of multiple traversing headers on one machine.

FIG. 5 is a side view similar to FIG. 3 with the addition of a housing 9, a vacuum or blower system attachment means to move air in 10 to the housing 9 and an air outlet 11 to remove the air with any moisture, liquid or debris which may be carried by the outlet air 11. The incoming air 10 may be directed so as to impinge 12 the surface 5 to be to be cleaned. The air may be heated or dried as needed. A seal device 13 may be used to assist in directing or controlling air or water flow.

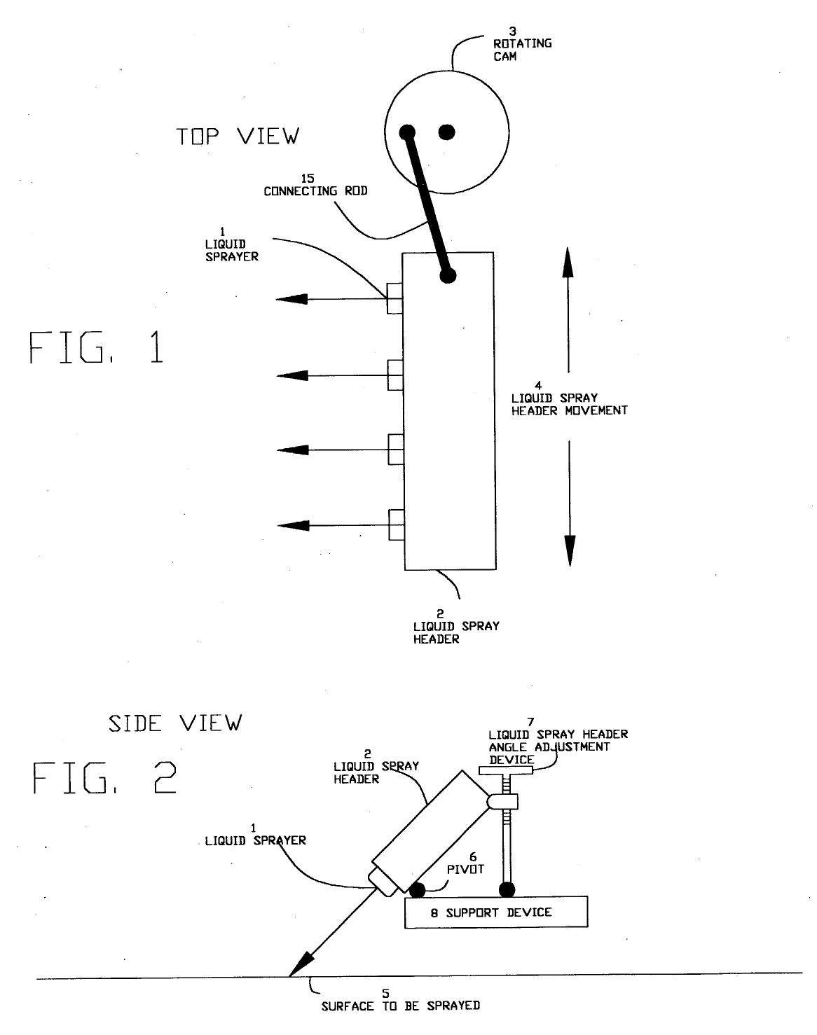

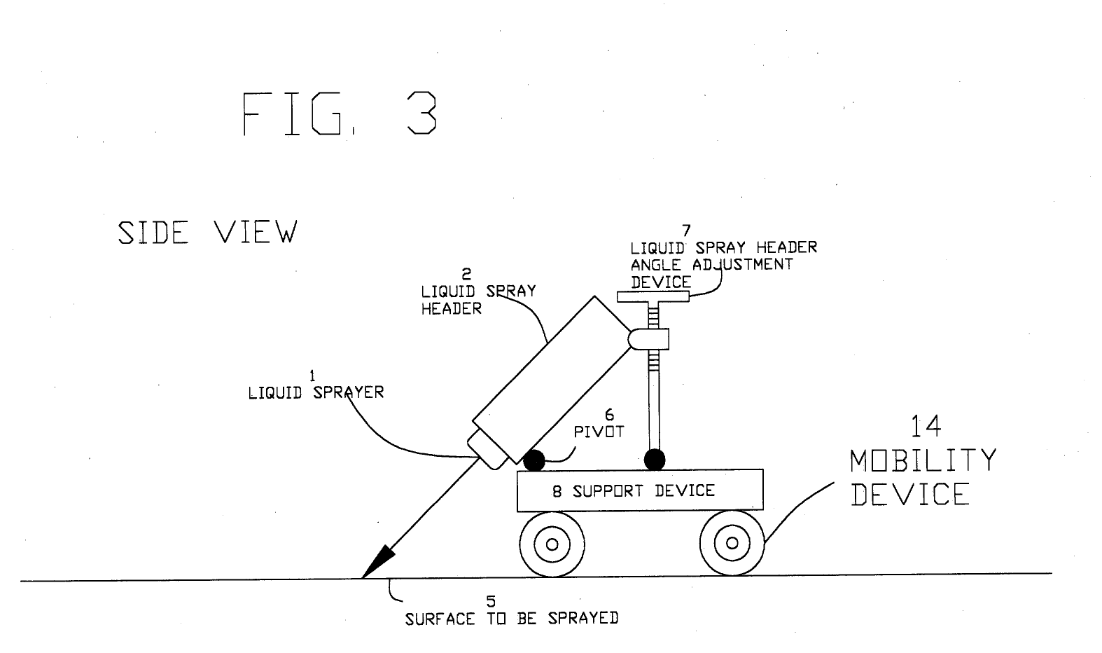

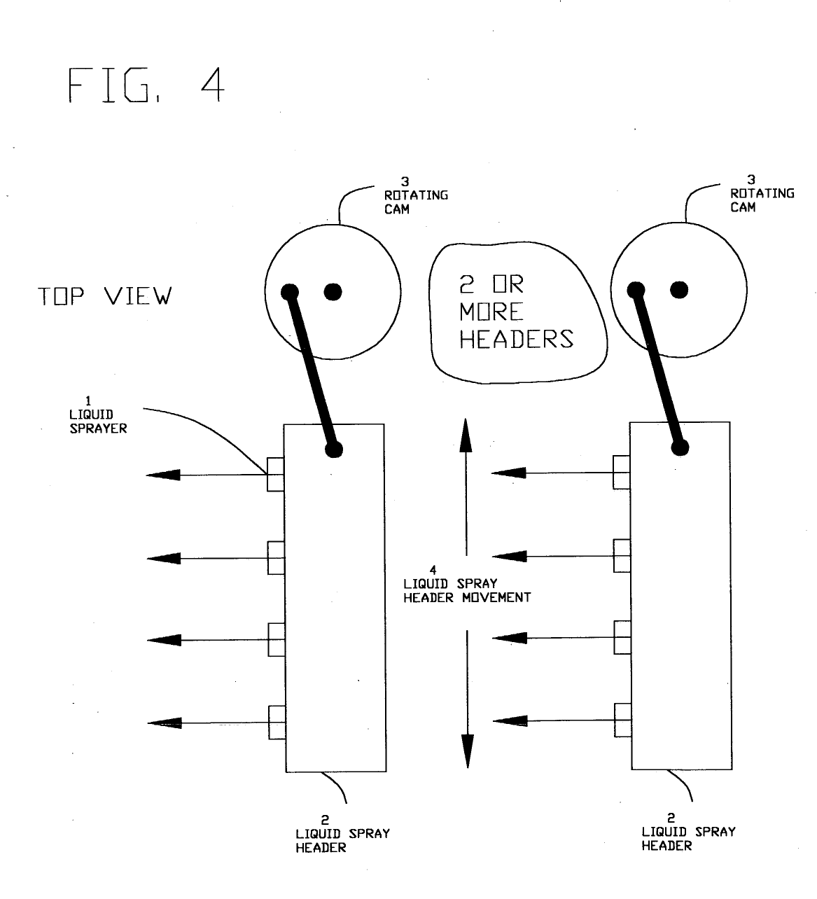

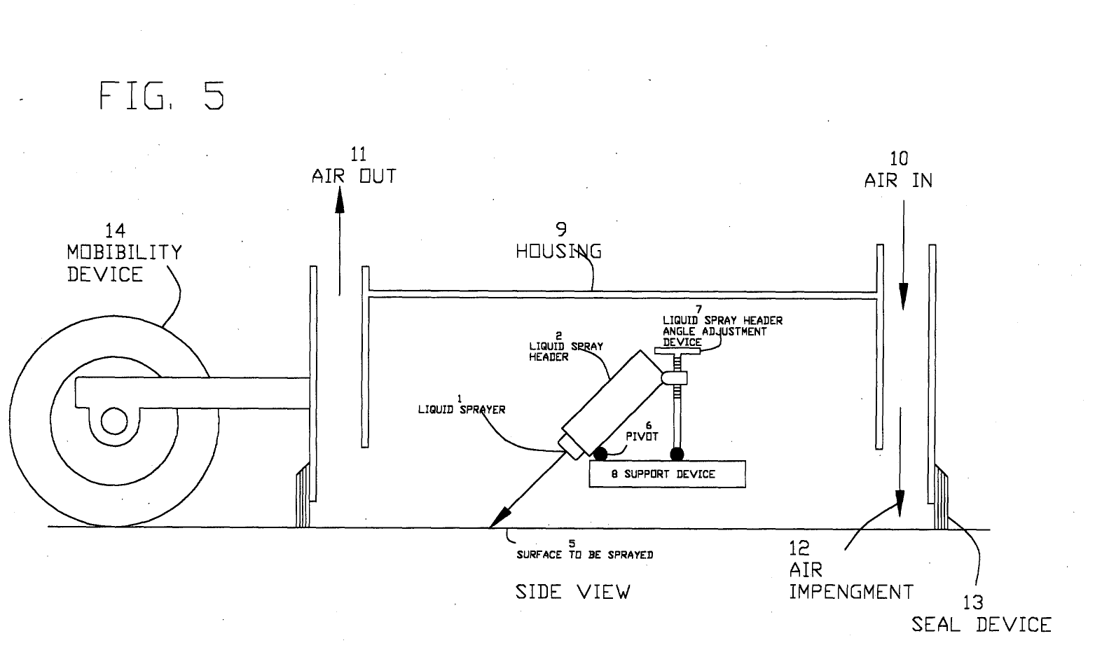

### DEFINITIONS

1—A liquid sprayer or spray head—device to direct liquid spray direction, pattern, concentration and/or velocity.

2—A liquid spray header—a device to mount & supply liquid to one or more 1 liquid sprayers or 1 spray heads.

3—Device to move the 2 spray header in other than a circular pattern. A 3 rotary cam or 3 pitmon rod may be used to move the 2 spray header. A preferred movement of the 2 spray header is back and forth parallel to the surface to be sprayed with the 1 liquid spray. A desired movement of the spray header is to be a 4 reciprocating motion or 4 triversing motion.

4—Movement of the 2 spray header in other than a circular pattern.

5—The surface to be sprayed by the 1 liquid sprayer

6—Pivot device on which the 1 spray head and or 2 spray header is pivoted in order to change the angle of attack between the sprayed liquid and the 5 surface to be sprayed.

7—Angle adjustment device used to change the angle at which the 1 liquid sprayer and/or 2 liquid spray header sprays liquid onto the 5 surface to be sprayed.

8—Support device to attach the 2 liquid spray header and/or 7 liquid spray header angle adjustment device and/or 14 mobility device.

9—Housing placed in proximity to the liquid spray unit in order to contain & direct the flow of air which is in proximity to the liquid sprayer unit.

10—Inlet conduit to transport air into the 9 housing. The 10 inlet air may be sucked into the 9 housing or blown into 9 housing. The 10 inlet air may be directed so as to 12 impinge the 5 surface to be sprayed. The 12 impingement of inlet air may assist in drying and/or cleaning the 5 surface to be sprayed.

11—Outlet conduit to transport air out of the 9 housing. The 11 outlet air may be sucked out or blown out of the 9 housing.

12—Device and means to impinge inlet air onto the 5 surface to be sprayed.

13—Seal device used to control the quantity of air and liquid entering or exiting the 9 housing.

14—Mobility device used to allow the 9 housing and/or liquid sprayer unit to be mobile.

15—Connector rod

### DESCRIPTION OF THE PREFERED IMBODIMENT

The preferred surface 5 cleaning or surface 5 conditioning pressure sprayer has one or more liquid sprayers 1 with a source of pressurized liquid. The sprayer 1 is mounted on one or more liquid spray headers 2. The header 2 is moved in a traversing motion by a connecting arm 15 attached to a rotary cam 3. An angle adjustment device 7 moves the header 2 on a pivot 6 in order to accomplish the most effective angle of attack for cleaning between the surface 5 to be cleaned an the pressurized liquid spray 1. The above described device may be mounted on a support 8 having a mobility means 14, a housing 9 to contain and manage liquid and air flow. Air flow, air velocity, air temperature, air dryness and air impingement may be adjusted to improve cleaning and drying of the surface to be cleaned.

1. A pressurized liquid spray nozzle mounted on a traversing support device.

2. The device in claim 1 having two or more pressurized liquid spray nozzle mounted on a traversing support device.

3. The device in claim 1 having two or more pressurized liquid spray nozzle mounted on a two or more traversing support device.

4. The device in claim 1 having a housing.

5. The device in claim 1 having a housing with a device to move air into or out of the housing.

6. The device in claim 1 having a housing with a device to move air into or out of the housing and having a device to heat the air or cool the air or dry the air or impinge the air against the surface to be conditioned or cleaned or a device to increase or decrease the velocity of the air movement.

7. The device in claim 1 having a housing with a device to move air, moisture, liquid, or debris out of the housing.

8. The device in claims 1,2,3,4,5,6 or 7 having a mobility device which may be hand powered or mechanically powered or robotically moved.
